(19) United States
(12) Patent Application Publication
(10) Pub. No.: US 2026/0229525 A1
(43) Pub. Date: Aug. 6, 2026

(54) BILAYER BATTERY BINDER STRUCTURE

(71) Applicant: FORD GLOBAL TECHNOLOGIES, LLC, Dearborn, MI (US)

(72) Inventors: Wei XU, Livonia, MI (US); Insik JEON, Novi, MI (US); Michael LERNER, Corvallis, OR (US); Jonghwan PARK, Ann Arbor, MI (US); Myoungshin HONG, Ann Arbor, MI (US); Minghong LIU, Canton, MI (US)

(21) Appl. No.: 19/042,956

(22) Filed: Jan. 31, 2025

(51) Int. Cl. H01M 4/62; H01M 4/02; H01M 4/04; H01M 4/587; H01M 4/66; H01M 50/414; H01M 50/46; H01M 50/491

(52) U.S. Cl. CPC H01M 4/622; H01M 4/0404; H01M 4/0409; H01M 4/0471; H01M 4/587; H01M 4/661; H01M 50/414; H01M 50/46; H01M 50/491; H01M 2004/021; H01M 2004/027

(57) ABSTRACT

A heterogeneous-binder electrode assembly and methods for forming electrodes for lithium-ion batteries are presented. The heterogeneous-binder electrode assembly includes a metal foil current collector, a non-porous layer adhered to the current collector that includes active material particles, a conductive agent, and a binder system containing carboxymethyl cellulose and styrene-butadiene rubber, and a porous carboxymethyl cellulose layer bonded to the non-porous layer to increase electrolyte infiltration and ion transport.

### TECHNICAL FIELD

This disclosure relates to battery manufacturing.

### BACKGROUND

To achieve high power performance in lithium-ion batteries, a balance of ionic and electrical conductivity, mechanical integrity, and electrolyte infiltration into the anode is required. Conventional single-layer coatings typically optimize one or two of these characteristics. Electronically insulating binders, such as carboxymethyl cellulose (CMC) and styrene-butadiene rubber (SBR), may be used to maintain mechanical strength.

### SUMMARY

An electrode assembly is provided. This electrode assembly includes a metal foil current collector, a non-porous layer including a mixture of active material particles, a conductive agent, and a binder system containing carboxymethyl cellulose and styrene-butadiene rubber, adhered to and in direct contact with the metal foil current collector, and a porous layer of carboxymethyl cellulose that facilitates electrolyte infiltration and ion transport, bonded to the non-porous layer. The active material particles may be selected from natural graphite, artificial graphite, silicon oxide, or silicon-carbon composites. The porous layer may have a porosity of 40% to 70%, while the non-porous layer may have a thickness of 10 to 30 microns, and the porous layer may have a thickness of 5 to 15 microns. The porous layer may further include conductive agents to increase electronic conductivity, and the binder system in the non-porous layer may have a weight ratio of carboxymethyl cellulose to styrene-butadiene rubber between 1:1 and 3:1. The porous layer may also contain aligned pores to facilitate ion transport. The metal foil current collector may be copper.

A method for forming an electrode is provided. This method includes applying a mixed binder slurry containing active material particles, a conductive agent, and a carboxymethyl cellulose and styrene-butadiene binder mixture onto a metal foil current collector, drying the mixed binder slurry to form a non-porous layer adhered to the metal foil current collector, applying a carboxymethyl cellulose slurry atop the non-porous layer, and drying the carboxymethyl cellulose slurry to form an electrode. The method may further include calendering the non-porous layer to achieve a target density before applying the carboxymethyl cellulose slurry. The carboxymethyl cellulose slurry may be applied by doctor blade coating, and drying of the mixed binder slurry may be conducted at a temperature between 80° C. and 120° C. The metal foil current collector may be pretreated to increase adhesion of the non-porous layer. The method may also include adding a surfactant to the carboxymethyl cellulose slurry and incorporating silicon-based composites as active material particles in the mixed binder slurry and the carboxymethyl cellulose slurry. Additionally, the method may include annealing the electrode at a temperature between 150° C. and 250° C. after forming the porous layer to increase layer bonding.

A negative electrode is provided. This electrode includes a current collector foil and a styrene-butadiene rubber layer sandwiched between and laminated with the current collector foil and a carboxymethyl cellulose and styrene-butadiene rubber binder matrix containing active material. The styrene-butadiene rubber layer may have a thickness between 1 and 5 microns, and the active material may be a blend of natural graphite and artificial graphite in a weight ratio of 2:1 to 3:1.

### BRIEF DESCRIPTION OF THE DRAWINGS

FIG. 1 is a schematic diagram of a homogenous coated electrode;

FIG. 2 is a schematic diagram of a heterogenous coated electrode;

FIGS. 3-6 are graphs of electrochemical performance characteristics of a homogenous coated electrode compared to a heterogenous coated electrode; and

FIG. 7 is a flow diagram of a process to form a heterogeneous coated electrode.

### DETAILED DESCRIPTION

In accordance with this disclosure, detailed embodiments of a heterogeneous-binder anode assembly for lithium-ion batteries are provided, including the structure, composition, and functional advantages of a dual-layer coating system. The bottom layer comprises a dual-binder composition of CMC and SBR to maintain adhesion and mechanical integrity, while the top layer has a single CMC binder to increase porosity, electrolyte infiltration, and electrical conductivity. These embodiments represent an innovative approach to addressing the trade-offs between mechanical strength, conductivity, and wettability inherent in conventional single-layer anode coatings. The figures and descriptions provided are illustrative and highlight key aspects of the layered binder system and its performance benefits. Certain features may be emphasized or simplified to clarify these aspects, and as such, the specific structural and operational details are not intended to limit the invention but to provide guidance to those skilled in the art for implementing various embodiments of the claimed invention. Variations in composition, structure, and configuration that remain within the scope of the invention are anticipated and intended to be covered by this disclosure.

Unless explicitly stated otherwise, all numerical values and ranges in this document—including dimensions, measurements, percentages, weights, layer thicknesses, and similar numerical references—should be interpreted as preceded by the term “about.” This interpretation applies throughout the disclosure, even where “about” is not specifically mentioned, to account for typical variations in measurement, manufacturing tolerances, material properties, and intended functionality. For instance, when the bottom layer loading is stated as “0.5 to 3 mg/cm²,” it should be understood as “about 0.5 to about 3 mg/cm².” Similarly, if the porosity of the top layer is described as “increased to facilitate electrolyte infiltration,” this includes reasonable variations that achieve the intended functionality. These inherent variations are included within the scope of the invention, ensuring practical implementation and adaptability across different manufacturing scenarios.

The present disclosure relates to a heterogeneous-binder coating system for graphite-based anodes in lithium-ion batteries. This heterogeneous-binder coating system uses a dual-binder composition of CMC and SBR in the bottom layer for strong adhesion and mechanical integrity while utilizing a single CMC binder in the top layer to increase porosity, electrolyte infiltration, and electrical conductivity. The bottom layer, which is applied directly onto a current collector, provides adhesion and structural support. The inclusion of SBR in this layer imparts elasticity, reducing the chance of delamination during cycling, while the combination with CMC maintains sufficient mechanical strength.

The use of only CMC in the top layer addresses the limitations of the bottom layer by increasing porosity and facilitating faster and more uniform electrolyte infiltration. The absence of the insulating SBR polymer in the top layer also increases electrical conductivity, reducing anode resistance and improving high-rate performance. This layered configuration balances the benefits of both binders, adjusting the anode for ionic and electrical conductivity, mechanical stability, and efficient electrolyte infiltration.

The proposed system offers several performance advantages over conventional homogeneous coatings. The layered configuration improves both ion and electron transport by combining the mechanical strength of the bottom layer with the increased conductivity and wetting properties of the top layer. The dual-binder bottom layer prevents delamination, maintaining long-term mechanical stability even under high-power cycling conditions. The increased porosity of the top layer reduces electrolyte infiltration time, lowering processing complexity and formation losses. Additionally, the system allows for flexibility in material selection, accommodating natural graphite (NG), artificial graphite (AG), blends of both, or composite materials containing silicon oxide (SiO) or silicon-carbon (SiC).

The heterogeneous-binder coating system also offers customizable layer thicknesses and binder ratios to meet specific performance requirements. The bottom layer typically has a loading weight of 0.5-3 mg/cm², while the top layer ranges from 5-10 mg/cm². Preliminary experiments demonstrate that this system reduces anode resistance by up to 15%, improves high-rate discharge capacity, and shortens electrolyte infiltration time by approximately 30% compared to homogeneous coatings. Furthermore, the anode maintains mechanical integrity over 500 cycles, with minimal delamination observed.

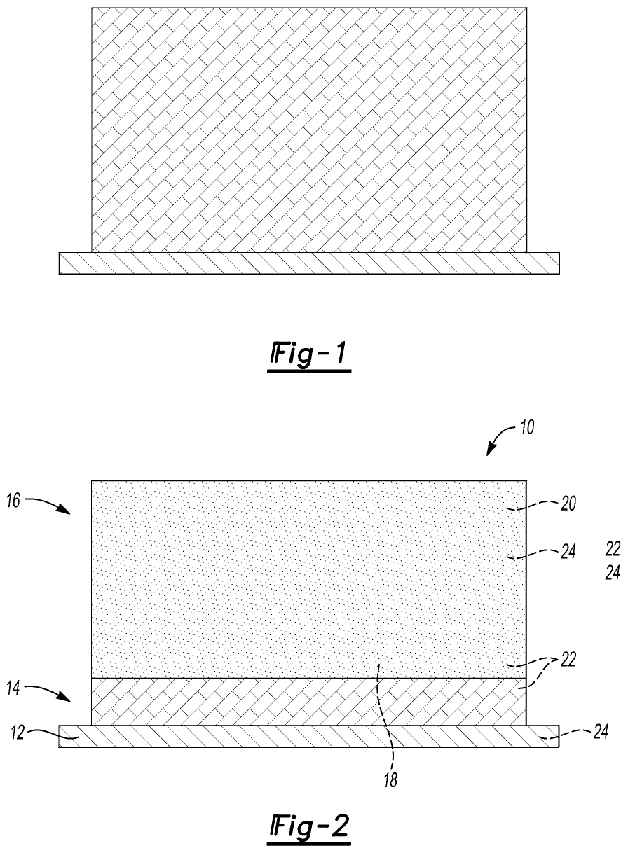

FIG. 1 is a conventional electrode design with a homogeneous coating applied to a metal foil current collector, commonly copper. The electrode structure is an anode layer with a uniform mixture of active material particles, a conductive agent, and a binder system. The binder typically includes a combination of CMC and SBR to provide both mechanical stability and adhesion to the current collector.

The homogeneous coating is characterized by its uniform distribution of materials throughout the anode layer. While this configuration offers simplicity in fabrication and a balanced approach to mechanical strength and ionic/electronic conductivity, it may have limitations. The uniform binder composition may restrict porosity, leading to reduced electrolyte infiltration and slower ion transport. Additionally, the even distribution of CMC and SBR binders often results in compromises between mechanical integrity and electronic conductivity, as the insulating nature of SBR may increase resistance within the anode.

The metal foil current collector, such as copper, is shown as the base of the electrode assembly. It functions as a conductive substrate for electron transport while mechanically supporting the anode layer. The homogeneous coating adheres directly to the current collector. While suitable for standard lithium-ion battery operations, this homogeneous design may struggle to meet the demands of high-power performance, where fast electrolyte wetting, increased ionic transport, and robust mechanical properties are necessary.

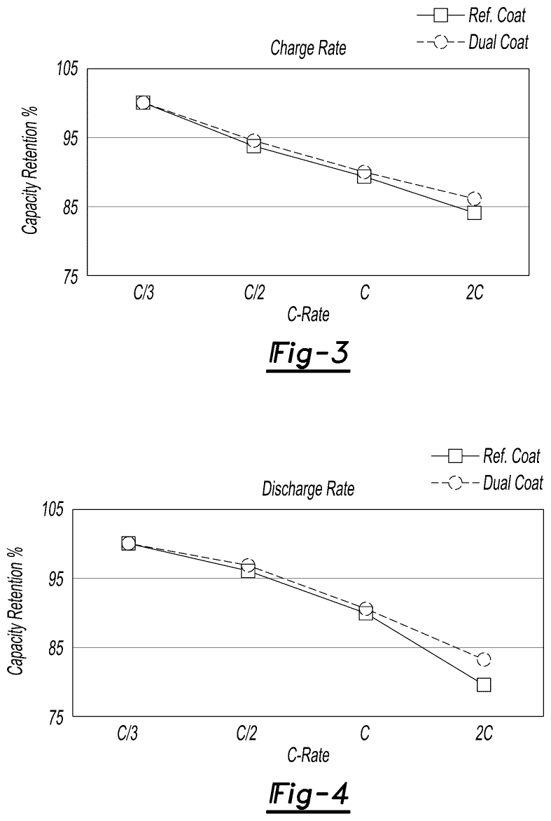

FIG. 2 shows an electrode 10 with a layered structure, including a current collector 12, a dual-binder layer 14, and a single-binder layer 16. This electrode 10 is a heterogeneous binder system that addresses the limitations of conventional homogeneous coatings, providing increased performance characteristics for lithium-ion batteries. The dual-binder layer 14 and the single-binder layer 16 are tailored to increase adhesion, mechanical integrity, electrolyte infiltration, and ionic/electrical conductivity.

The current collector 12 serves as the foundational substrate of the electrode 10. The current collector 12 is typically composed of a conductive metal foil, such as copper, and provides the mechanical support and electronic conductivity necessary for operation of the electrode 10. The current collector 12 maintains electron transport to and from the dual-binder layer 14 and the single-binder layer 16 during cycling. In some embodiments, the current collector 12 may be pretreated to increase adhesion between the current collector 12 and the dual-binder layer 14, further increasing the mechanical stability of the electrode 10.

The dual-binder layer 14 is positioned directly atop the current collector 12 and contains a mixture of two binders 18 in a binder matrix. These binders may typically include CMC and SBR, which work together to provide mechanical strength, elasticity, and robust adhesion to the current collector. The dual-binder layer 14 in their matrix structure also encapsulates electrode active material 22, such as graphite or silicon-based composites, which serve as the primary sites for lithium-ion intercalation, and conductive agents 24, such as carbon black or acetylene black, to increase electronic conductivity throughout the dual-binder layer 14. The composition and structure of the dual-binder layer 14, sandwiched between and laminated with the current collector 12 and the single-binder layer 16, maintains strong adhesion to the current collector 12 and provides a mechanically stable base for the electrode 10, preventing delamination during cycling.

The single-binder layer 16 is formed on top of the dual-binder layer 14 and contains a single binder 20, typically CMC. The single-binder layer 16 is configured to increase porosity, enabling increased electrolyte infiltration and faster ion transport. Like the dual-binder layer 14, the single-binder layer 16 also contains electrode active material 22 and conductive agents 24 to maintain ionic and electronic conductivity. The absence of an insulating binder, such as SBR, in the single-binder layer 16 reduces resistance and allows for increased electron flow. In some embodiments, the slurry used to form the single-binder layer 16 may also include surfactants to control pore size distribution and increase uniformity.

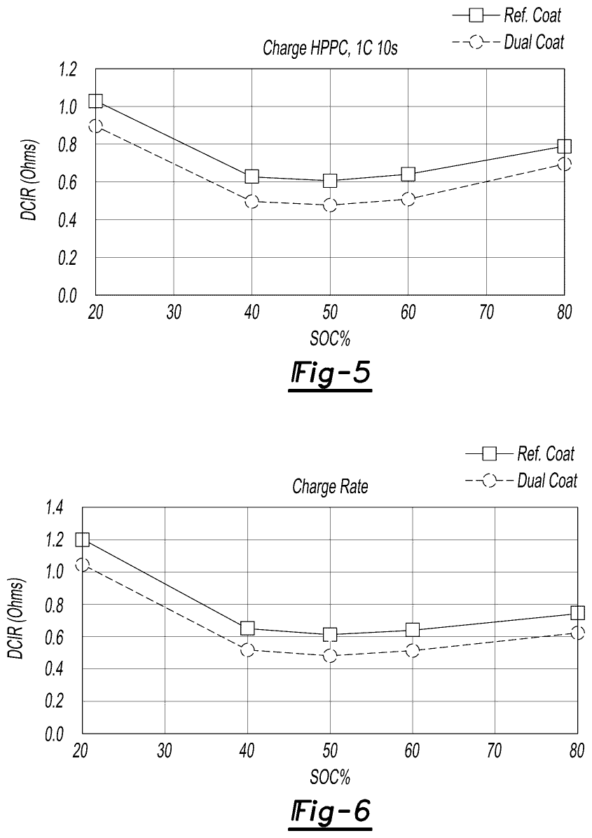

FIGS. 3-6 show the performance advantages of the disclosed heterogeneous electrode with a dual-binder coating (referred to as “Dual coat”) compared to a conventional reference coating (referred to as “Ref. coat”). FIGS. 3-6 evaluate capacity retention, charge/discharge rates, and dynamic charge resistance under various conditions.

FIG. 3 is a charge rate performance graph showing the capacity retention (%) of the electrodes under varying charge rates (C-rate), ranging from C/3 to 2 C. Capacity retention is an indicator of the electrode's ability to maintain charge capacity under increasing rates of current. The dual-binder coating consistently outperforms the reference coating across all charge rates, maintaining higher capacity retention as the rate increases. This improved performance is attributed to the increased ionic conductivity and electrolyte infiltration provided by the porous single-binder layer, which facilitates efficient ion transport even at high charging rates.

FIG. 4 is a discharge rate performance graph showing the capacity retention (%) under varying discharge C-rates, from C/3 to 2 C. Similar to the charge rate results in FIG. 3, the dual-binder coating exhibits superior performance, retaining a higher percentage of capacity compared to the reference coating. The dual-binder layer's strong mechanical adhesion ensures structural stability during high-rate discharges, while the single-binder layer's increased porosity increases ion transport and mitigates performance losses under high current conditions.

FIG. 5 is a charge hybrid pulse power characterization (HPPC) resistance graph showing the dynamic charge resistance (DCR) at a 1 C charge rate over a 10-second pulse, plotted as a function of state of charge (SOC %). The dual-binder coating demonstrates lower DCR values across the SOC range compared to the reference coating. This reduction in resistance is directly linked to the increased electronic and ionic pathways provided by the conductive agents and binder system in the dual-binder layer. The lower charge resistance translates to more efficient charging, particularly at intermediate SOC levels, where battery performance is needed.

FIG. 6 is a discharge HPPC resistance graph showing dynamic DCR at a 1 C discharge rate over a 10-second pulse, again as a function of SOC %. The dual-binder coating shows a marked reduction in DCR compared to the reference coating across all SOC levels. This improvement reflects the benefits of the heterogeneous binder structure, where the porous single-binder layer facilitates faster ion transport during discharge, and the mechanically robust dual-binder layer provides consistent performance under cycling conditions.

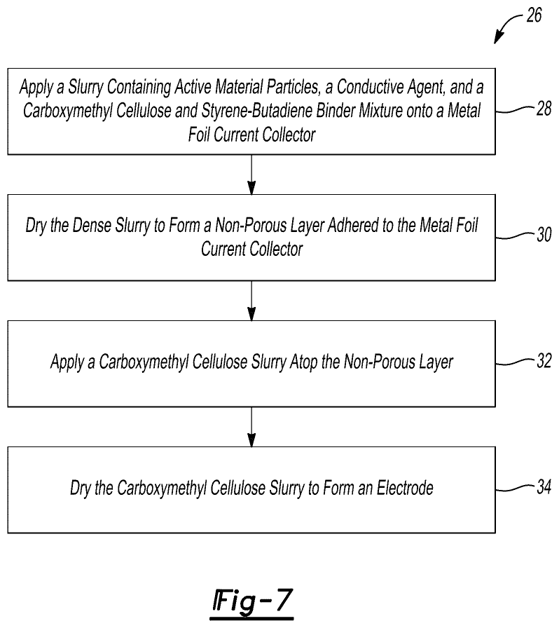

FIG. 7 is a method 26 for fabricating a heterogeneous electrode assembly using a layered binder approach to form an electrode with increased mechanical integrity, ionic and electronic conductivity, and efficient electrolyte infiltration. In step 28 a slurry containing active material particles, a conductive agent, and a binder mixture of CMC and SBR is applied to a metal foil current collector. The metal foil, typically copper, serves as the conductive substrate for the electrode. The dual-binder slurry forms the base layer of the electrode, combining the adhesive and elastic properties of SBR with the structural support of CMC. The active material particles, such as graphite or silicon-based composites, enable lithium-ion intercalation, while the conductive agents, such as carbon black or acetylene black, promote effective electronic conductivity throughout the layer. In some embodiments, the slurry may include surfactants to increase dispersion of the binder and conductive agents, to maintain a uniform layer structure. Additionally, the metal foil current collector may be pretreated to increase adhesion between the current collector and the dual-binder layer.

In step 30 the applied slurry is dried to form a non-porous layer that securely adheres to the metal foil current collector. This dense layer provides a mechanically robust foundation for the electrode, reducing the chance of delamination during battery cycling. The drying process is conducted at temperatures typically ranging from 80° C. to 120° C., depending on the binder composition and processing requirements. Calendering may be performed after drying to achieve the target density and mechanical strength of the non-porous layer, to maintain a stable base for subsequent layers.

In step 32, a second slurry, including CMC, is applied atop the dried non-porous layer. This single-binder slurry forms the porous layer of the electrode, specifically designed to increase electrolyte infiltration and ionic transport. By excluding SBR, this layer reduces resistance and increases porosity, enabling faster and more uniform ion diffusion during operation. Surfactants may be added to the CMC slurry to control pore size distribution and increase uniformity across the porous layer.

In step 34, the single-binder slurry is dried to form the porous layer, which adheres to the non-porous base layer, completing the heterogeneous electrode assembly. The drying process for this layer is configured to preserve porosity for efficient electrolyte wetting and superior ionic conductivity. Post-drying, the electrode assembly may undergo an annealing process at temperatures between 150° C. and 250° C. to increase the bonding between the layers and further increase mechanical integrity. This stepwise method 26 creates the dual-layer structure, which incorporates the mechanical integrity of the base layer with the increased transport properties of the porous layer. The method 26 is adaptable to various active materials and conductive agents, making it suitable for high-power and fast-charging applications in lithium-ion batteries.

While specific embodiments of the heterogeneous-binder anode system are described in detail—such as the use of a copper foil current collector, a dual-binder bottom layer, and a single-binder top layer to increase performance—these examples are not intended to limit the invention to these particular configurations. The disclosure uses illustrative language to explain the principles and advantages of the invention but should not be interpreted as restricting its scope. Variations and modifications in the composition, structure, and processing methods may be made without departing from the core principles of the invention. Additionally, the described features and elements may be combined or rearranged in various configurations to create additional embodiments. For example, the use of alternative anode materials, such as artificial graphite or silicon-based composites, or adjustments to the layer thicknesses, binder ratios, or manufacturing processes, would also fall within the scope of the invention. All such variations are contemplated and are considered within the scope of the claims.

What is claimed is:

1. An electrode assembly comprising:
a metal foil current collector;
a non-porous layer including a mixture of active material particles, a conductive agent, and a binder system containing carboxymethyl cellulose and styrene-butadiene rubber, adhered to and in direct contact with the metal foil current collector; and
a porous layer of carboxymethyl cellulose configured to facilitate electrolyte infiltration and ion transport, bonded to the non-porous layer.

2. The electrode assembly of claim 1 wherein the active material particles in the non-porous layer are selected from a group including natural graphite, artificial graphite, silicon oxide, and silicon-carbon composites.

3. The electrode assembly of claim 1 wherein the porous layer has a porosity of 40% to 70%.

4. The electrode assembly of claim 1 wherein the non-porous layer has a thickness of 10 to 30 microns.

5. The electrode assembly of claim 1 wherein the porous layer has a thickness of 5 to 15 microns.

6. The electrode assembly of claim 1, further comprising conductive agents in the porous layer.

7. The electrode assembly of claim 1 wherein the binder system in the non-porous layer has a weight ratio of carboxymethyl cellulose to styrene-butadiene rubber between 1:1 and 3:1.

8. The electrode assembly of claim 1 wherein the porous layer contains aligned pores to facilitate ion transport.

9. The electrode assembly of claim 1 wherein the metal foil current collector is copper.

10. A method for forming an electrode comprising:
applying a mixed binder slurry, containing active material particles, a conductive agent, and a carboxymethyl cellulose and styrene-butadiene binder mixture, onto a metal foil current collector;
drying the mixed binder slurry to form a non-porous layer adhered to the metal foil current collector;
applying a carboxymethyl cellulose slurry atop the non-porous layer; and
drying the carboxymethyl cellulose slurry to form an electrode.

11. The method of claim 10, further comprising calendering the non-porous layer to achieve a target density before applying the carboxymethyl cellulose slurry.

12. The method of claim 10 wherein the carboxymethyl cellulose slurry is applied by doctor blade coating.

13. The method of claim 10 wherein drying the mixed binder slurry is conducted at a temperature between 80° C. and 120° C.

14. The method of claim 10 wherein the metal foil current collector is pretreated to increase adhesion of the non-porous layer.

15. The method of claim 10, further comprising adding a surfactant to the carboxymethyl cellulose slurry.

16. The method of claim 10 wherein the active material particles in the mixed binder slurry and the carboxymethyl cellulose slurry include silicon-based composites.

17. The method of claim 10, further comprising annealing the electrode at a temperature between 150° C. and 250° C. after forming the porous layer.

18. A negative electrode comprising:
a current collector foil;
a carboxymethyl cellulose and styrene-butadiene rubber binder matrix containing active material; and
a styrene-butadiene rubber layer sandwiched between and laminated with the current collector foil and carboxymethyl cellulose and styrene-butadiene rubber binder matrix.

19. The negative electrode of claim 18 wherein the styrene-butadiene rubber layer has a thickness between 1 and 5 microns.

20. The negative electrode of claim 18 wherein the active material is a blend of natural graphite and artificial graphite in a weight ratio of 2:1 to 3:1.
